(19) United States
(12) Patent Application Publication
(10) Pub. No.: US 2007/0035392 A1
(43) Pub. Date: Feb. 15, 2007

(54) Locator

(76) Inventor: Terry Dean Smith, Lakeview, OR (US)

Correspondence Address: Terry Dean Smith, P.O. Box 1135, Lakeview, OR, 97630, US

(21) Appl. No.: 11/062,912

(22) Filed: Aug. 9, 2005

(51) Int. Cl. G08B 1/08

(52) U.S. Cl. 340/539.32

(57) ABSTRACT

To the best of my knowledge “The Locator” is the only stand alone device of its kind specifically designed to locate misplaced items around the home or work place. At my house we are constantly looking for either one of the remote controls used for the television or a set of house/car keys. Having a device that's sole purpose is to help us find misplaced items would be of tremendous help to us. It would certainly go a long way in creating harmony in the home.

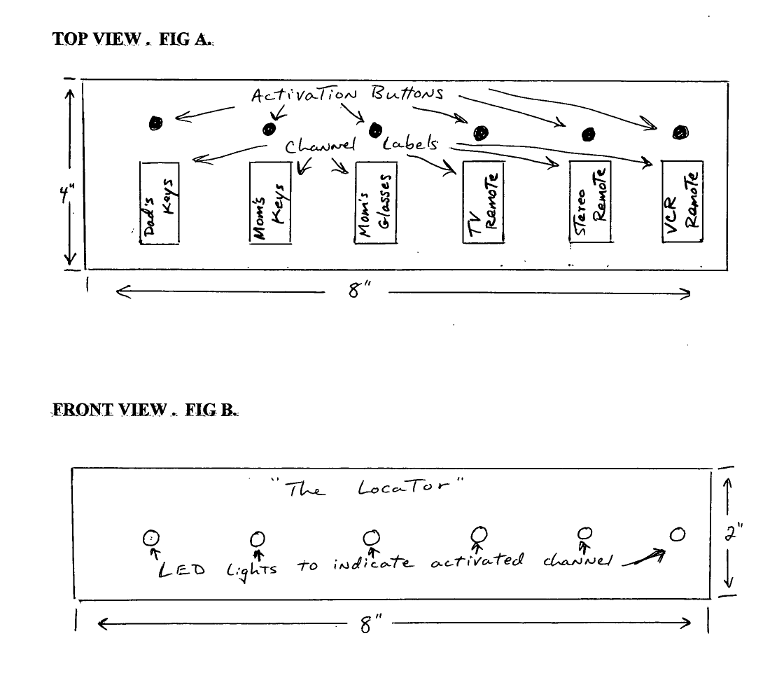

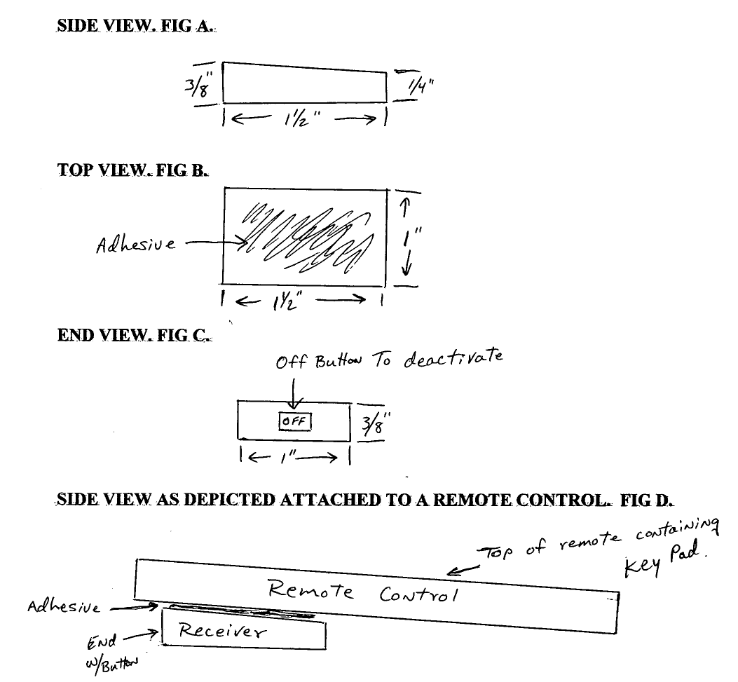

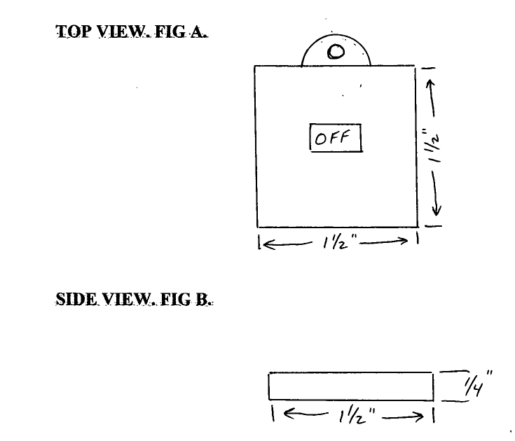

The Locator is an electronic device that is designed to transmit a signal to a receiving device that will then emit an audible sound until it is shut off. The transmitter should have several channels in order to accommodate multiple receiving devices. The idea is to attach receiving units to various items such as audio/visual device remote controls, car/house keys, purses, brief cases, or any such item that is commonly misplaced around the home or work place. Once the specific channel on the transmitter is activated for the particular item that is misplaced the receiving unit attached to that item will then emit a loud audible noise until the item is found and shut off. The following is provided.

### CROSS REFERENCE TO RELATED APPLICATIONS

Not Applicable.

### STATEMENT REGARDING FEDERALLY SPONSORED RESEARCH OR DEVELOPMENT

Not Applicable.

### REFERENCE TO SEQUENCE LISTING, A TABLE, OR A COMPUTOR PROGRAM LISTING COMPACT DISC APPENDIX

Not Applicable.

### BACKGROUND OF INVENTION

The idea for this invention grew out of the personal need to locate misplaced items around my home.

### BRIEF SUMMARY OF THE INVENTION

“The Locator” is designed to help a person find misplaced items around the home or workplace. In my home we are constantly looking for misplaced items such as the car keys, television remote control, or reading glasses.

Having an electronic device such as the “The Locator” whereas a person could activate a transmitter which would then activate a receiver attached to personal property such as car keys and thereby emit an audible sound would be of tremendous benefit.

This would enable a person to follow the sound emitted from the receiver until the misplaced item is located and the receiver deactivated.

### BRIEF DESCRIPTION OF THE SEVERAL VIEWS OF THE DRAWINGS

ITEM NUMBER I. Sheet One of Three. Contains two drawings.

Drawing One. FIG. A is the top view of the transmitter. The drawing depicts places for labels in order to identify the different channels. Each channel corresponds to a receiver which is attached to a personal item such as a pair of reading glasses or house keys. This drawing also depicts activation buttons. When an activation button is pressed it then activates the signal to the receiver.

Drawing Two. FIG. B is the front view. The drawing shows the name of the device, “The Locator”, as it may appear on the front. It also depicts LED (light emitting diodes) lights which indicate that a particular channel has been activated. ITEM NUMBER II. Sheet Two of Three. Contains four drawings.

Drawing One. FIG. A is the side view of the remote control receiver attachment. This device will be attached to the remote control, or any other device as determined by the owner, with some type of adhesive such as double sided adhesive tape.

Drawing Two. FIG. B is the top view of the receiver attachment. The top of the attachment will house the adhesive.

Drawing Three. FIG. C is the end view of the receiver attachment. The end of the receiver will house the off button which will deactivate the receiver when depressed.

Drawing Four. FIG. D is a depiction of how the receiver will look when attached two a device such as a television remote control. ITEM NUMBER III. Sheet Three of Three. Contains two drawings.

Drawing One. FIG. A is the top view of the key ring receiver unit. The top of the receiver will house the off button which will deactivate the receiver when depressed.

Drawing Two. FIG. B is the side view of the key ring receiver unit.

### DETAILED DESCRIPTION OF THE INVENTION

It is my intention to sell the idea for “The Locator” to a qualified electronics manufacturer or their representative. “The Locator” is an electronic device which is designed to help an individual locate a misplaced item. When one of the activation buttons on the transmitter is depressed it then transmits a signal to a receiver which then emits an audible sound until it is deactivated. By following the sound the individual is then able to locate the device they are searching for such as a set of keys or a television remote control that is in another room or under a couch cushion.

“The Locator” is a “Stand Alone” device. By “Stand Alone” I mean a device that is manufactured separately from any other device or housed in another device. Its components are a Transmitter Unit and various corresponding Receiver Units.

1. The locator is an electronic device designed to help the average citizen to locate misplaced items such as keys, purses/wallets, remote control devices, brief cases, and any other such item as the individual so desires. I therefore request that the patent provide appropriate protection for my patent idea and it's title “The Locator”. I specifically request that the patent protection cover my idea for a stand alone electronic device that is designed to transmit a signal to another device that is designed to receive that signal and thereby emit an audible sound until the misplaced item is located and it is shut off.
